(19) United States
(12) Patent Application Publication
(10) Pub. No.: US 2007/0271348 A1
(43) Pub. Date: Nov. 22, 2007

(54) System and method of fault-tolerant and privacy-safe location tracking via email

(76) Inventor: Sung Yang, Surrey (CA)

Correspondence Address: MARK S. HUBERT P.C., 516 SE MORRISON- SUITE 1200, PORTLAND, OR, 97214, US

(21) Appl. No.: 11/801,458

(22) Filed: May 9, 2007

Related U.S. Application Data
(60) Provisional application No. 60/747,560, filed on May 18, 2006.

(51) Int. Cl. G06F 15/16

(52) U.S. Cl. 709/206

(57) ABSTRACT

The present invention is a location tracking method installed or embedded in an electronic device as an agent (for example software, firmware or hardware) that determines the location of the device and sends the location information to an owner's email address directly or via a relay agent in a fault-tolerant and privacy-safe manner. Others can not track whereabouts of the owner and the device. The method does not use any monitoring server (or system) and does not use any personally identifying information to protect privacy of the device owner. The system's enhanced privacy, multiple redundant location determination and location information delivery system that overcomes such common problems as: the need for a dedicated location monitoring system; location determination errors; IP address blocking; port blocking; owner's email account failure; and other obstacles that hinder location information delivery to an owner's email address. Additionally this system has an optional data destruction function that can be activated by a remote control program to destroy data on the device once the device establishes connection with the remote control program in an owner's computer.

This application claims benefit under 35 U.S.C. § 121 of U.S. provisional application Ser. No. 60/747,560, filed May 18, 2006, incorporated herein in its entirety by reference.

### BACKGROUND OF THE INVENTION

The present invention relates to a system and method for the location tracking of an object, and more particularly to a method for locating an electronic device via Internet email providing an enhanced level of security for the owner.

Various location tracking systems and methods exist to locate electronic devices (especially portable electronics) via the Internet, for example, U.S. Pat. No. 6,244,758 and No. 6,300,863. The conventional system and methods comprise a client and a monitoring server (or system). The client is a software, firmware or hardware device embedded (or installed) in an electronic device, connects to a monitoring server via the Internet. The monitoring server determines the location of the client upon connection. Thus client and server are essential components however, emails are not as essential in the conventional methods. The prior art conventional tracking systems and methods are lacking in two critical areas, fault-tolerance and privacy.

In the existing conventional location tracking methods, monitoring servers track electronic devices (generally portable laptops and other portable electronics), which are commonly transported to a variety of locations by the user/owner. As a result, the owners are also tracked at the same time and their whereabouts are disclosed to the monitoring server. For example, a tracking service provider with one million customers has knowledge of whereabouts of their one million customers in the present and the past because the company's monitoring server tracks the electronic devices that their customers carry. Such tracking methods can not guarantee the complete privacy of the customers.

In order for the monitoring server (or system) to determine location, a client embedded or installed in an electronic device must establish a connection to the monitoring server. This connection can easily be thwarted by network firewalls, which are located between the monitoring server and the client. For example, a client attempts to connect to a monitoring server whose IP (Internet Protocol) address is 100.100.100.100 and TCP (Transmission Control Protocol) port number is 10. When a firewall located between the server and the client does not allow a connection to the IP address 100.100.100.100 or does not allow data traffic to the port 10, the necessary connection will fail. When the client is moved from one location to another, the client is subject to yet another firewall whose configuration is unknown and unpredictable. There is no guarantee that the firewall configuration will allow the relocated client to connect to the monitoring server. This is especially true when the device is in possession of a thief.

There are also other causes of tracking failure. In the way of an example, if the monitoring server is unavailable for any of a plethora of reasons, the client's attempts to connect to the monitoring server will fail.

U.S. Pat. No. 5,898,391 by Jefferies et al also depends on a monitoring system (or server). But the monitoring system is used to receive location information from a client instead of determining location of a client (upon client connection). This method also lacks in privacy safety, and incurs the monitoring system overhead.

A monitoring serverless method, U.S. Pat. No. 6,940,407 by Miranda-Knapp et al mentions transmitting location information to a phone number, voicemail or email. However, this method lacks adequate fault-tolerance with regard to its email transmissions. This method is also not applicable for tracking USB flash drive locations. Furthermore, this method is not practical with various Internet connection such as a landline Internet connection.

Other monitoring serverless methods that send an Internet email to user's email address from a computer have different problems. After receiving the email, the email header can be analyzed to extract the IP address of the computer that sends the email. However the (public) IP address alone is not always sufficient to determine precise location of the computer. Since this method uses ISP (Internet Server Provider)'s SMTP (Simple Mail Transfer Protocol) server to send emails, the email delivery will likely fail when the computer is transported outside of ISP's network. Further, this method is not feasible in tracking various other items such as USB flash drives and vehicles.

The present invention utilizes an enhanced privacy, multiple redundant location determination and location information delivery system that overcomes the following problems: the need for a dedicated location monitoring system; location determination errors; IP address blocking; port blocking; owner's email account failure; and other obstacles that hinder location information delivery to an owner's email address. Additionally this system has an optional data destruction function that can be activated by a remote control program to destroy data on the device once the device establishes connection with the remote control program, which is installed in an owner's computer

Thus, the present invention utilizes and combines known and new technologies in a unique and novel configuration to overcome the shortcomings in privacy and reliability of the existing location tracking methods and fulfills a long felt need in the industry.

### SUMMARY OF THE INVENTION

The general purpose of the present invention, which will be described subsequently in greater detail, is to provide an improved, reliable and privacy-safe location tracking method and system for tracking various electronic devices via email that is able to overcome the shortcomings of prior art systems and provide an enhanced level of security and privacy for the users.

It has many of the advantages mentioned heretofore and many novel features that result in a new tracking system which is not anticipated, rendered obvious, suggested, or even implied by any of the prior art, either alone or in any combination thereof.

In accordance with the invention, an objective of the present invention is to provide a reliable and privacy-safe location tracking means for tracking non-electronic devices via email.

Yet another objective of the invention is to help locate and recover stolen or lost portable electronic devices and protect data in the device.

It is another object of this invention to provide an improved cost effective tracking system that entirely eliminates location monitoring server (or system) and its overhead.

It is a further object of this invention to provide enhanced privacy, multiple redundant location determination and location information delivery system that overcomes problems in location determination errors, IP address blocking, port blocking, owner's email account failures, the need for a dedicated location monitoring system, and other obstacles that hinder location information delivery to owner's email address.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements. Other objects, features and aspects of the present invention are discussed in greater detail below.

### BRIEF DESCRIPTION OF THE DRAWINGS

FIG. 1 is a drawing of an embodiment of the present invention for the tracking of an USB flash drive;

FIG. 2 is a drawing of the partitioning a USB flash drive;

FIG. 3 is a flow chart of the tracking program;

FIG. 4 is a flow chart illustrating the steps for the installation of the location tracking program in a USB flash drive;

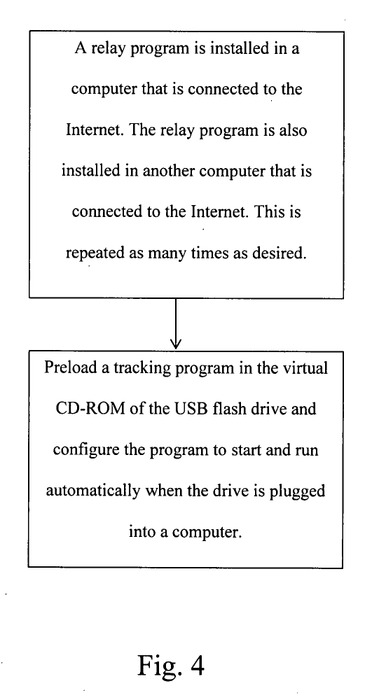

FIG. 5 is a drawing showing detailed steps of establishing the connection between the tracking program and the relay program;

FIG. 6 is a flow chart for the relay program;

FIG. 7 is a flow chart illustrating how the tracking program and relay program determine an email receiving computer for an owner's email address;

FIG. 8 is a location information email example;

FIG. 9 is an alternative location information email with optional device identification as well as GPS coordinates;

FIG. 10 is a representative drawing of an embodiment of the present invention for tracking a laptop;

FIG. 11 is a representative drawing of an embodiment for tracking vehicle;

FIG. 12 is a representative drawing showing the broad applications of the present invention;

FIG. 13 is an elaborated diagram of an email address 109 in FIG. 1; and

FIG. 14 is an illustration of dual-use of an email receiving computer for receiving emails and displaying email content.

### DETAILED DESCRIPTION

There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims appended hereto.

As used in this document, an IP address is a unique numeric address of a device attached to the Internet. An IP address is also called public IP address (or external IP address), which is routable. Some addresses are reserved for internal use only in local area networks. For example, from 192.168.0.0 to 192.168.255.255 are reserved for internal use only (in IP version 4). These addresses are called private IP addresses (or internal IP addresses), which are non-routable. Throughout this document, an IP address means a public IP address unless specifically disclosed as otherwise.

In the way of a simplified overview, the location tracking method of the present invention is installed or embedded in an electronic device as an agent (software, firmware or hardware) which determines the location of the device and sends a location information notification to the owner's email address directly or via a relay agent in a fault-tolerant and privacy-safe manner.

This tracking method recovers from encountered faults during its operation and continues to send location information to the owner's email address while protecting the privacy of the device's owner. For fault-tolerance, the invention uses several location determination methods for redundancy in the event one method fails. After successful location determination, the location information (as an email) is directly sent to an owner's email address. If the direct delivery of the email fails, the email is sent via any one of relay agents, which are installed and running in multiple number of remote computers that are connected to the Internet. Various techniques are used to overcome faults and ensure a successful delivery of the location information email.

To prevent others from monitoring the device and tracking whereabouts of the owner, the location of the electronic device is determined and sent to the owner without using a monitoring server (or system). In addition, owner's personally identifying information is neither used nor collected for complete owner's privacy and anonymity. Thus the privacy of the owner remains safe.

The elements and operation of the present invention are best explained with reference to its best mode use in the tracking of electronic devices, in this example, a USB flash drive. Alternative embodiment uses are described thereafter. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

### An Embodiment for Tracking USB Flash Drive

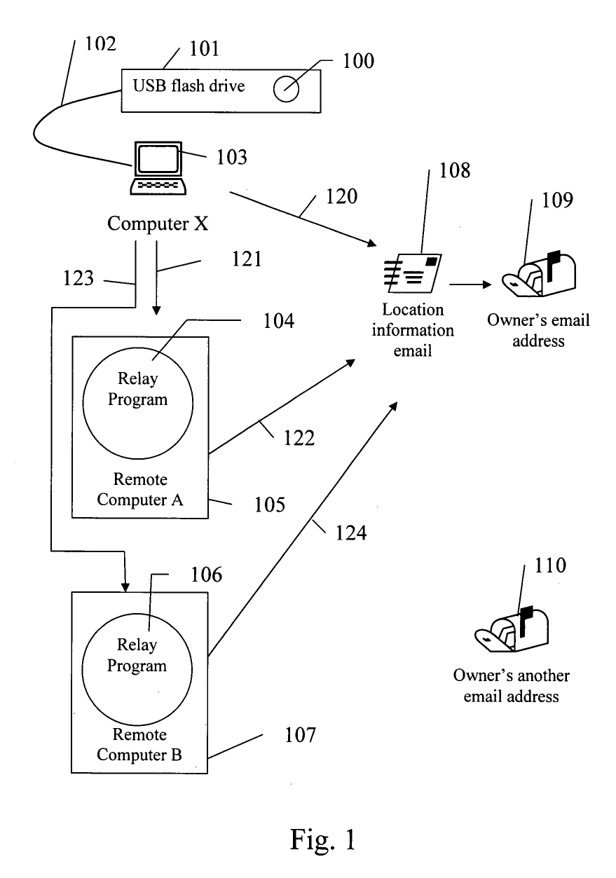

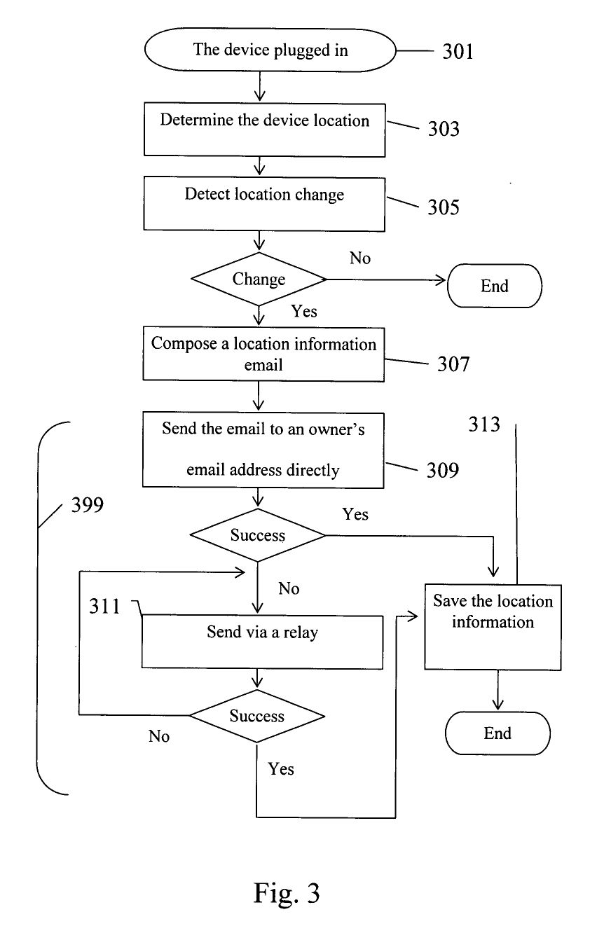

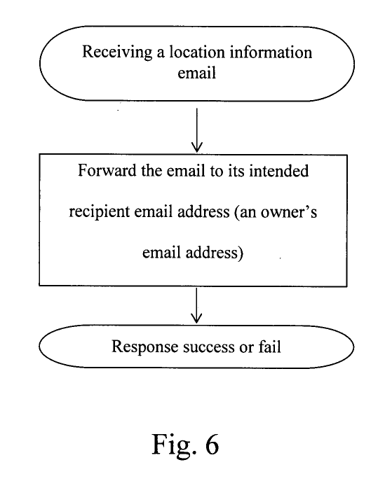

Looking at FIG. 1, the preferred embodiment of the invention tracks location of a USB (Universal Serial Bus) flash drive 101 and consists of two components. A self-location tracking program (in short ‘tracking program’) 100 and a location information email relay program (in short ‘relay program’) 104. A tracking program is an electronic device location tracking program that determines location of the device in which it is embedded (or installed) and sends the location information to an owner's email address directly or via a relay program (FIG. 3). A relay program is a dedicated location information email relay program that receives emails from the tracking programs through any one of TCP (Transmission Control Protocol) ports and immediately forwards the emails to its intended recipient email address, which is the owner's email address (FIG. 6). Relay programs use any of the available TCP port ranges from 0 to 65536. Nevertheless, the range may be narrowed if it is desired for performance benefits. For example: A range of port numbers from 0 to 1023; A range of port numbers from 5 to 65536; or a list of port numbers 20, 25, 80 100, 200, 300 and 400. To avoid a conflict, the relay program only uses free or available ports within the specified range.

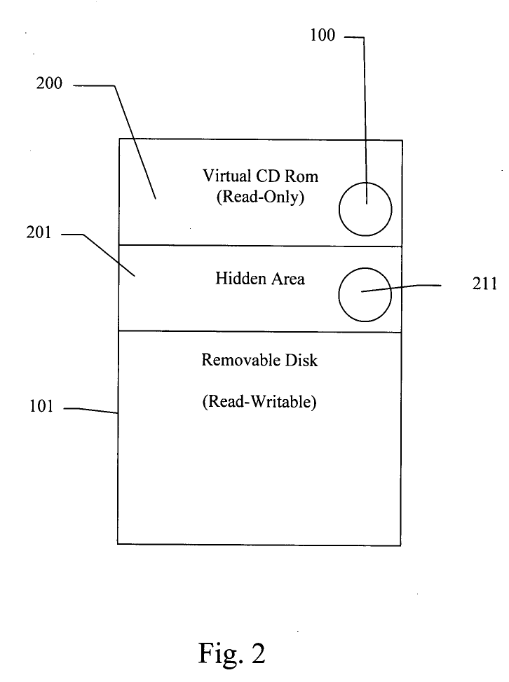

Looking at FIG. 1 and FIG. 2, it can be seen the tracking program 100 is preloaded in the virtual CD-ROM partition 200 of a USB flash drive 101 and configured to automatically start and run when connected to a computer X 103. The tracking program file name, e.g. tracking.exe, is inserted in to autorun.inf file in the virtual CD-ROM 200 in the preloading process. The inclusion of the filename in the autorun.inf allows the tracking program 100 to automatically run when the USB flash drive 101 is plugged into a USB port 102 of a computer 103, which runs a Microsoft Windows operating system such as Windows 98SE, ME, 2000, XP, or later versions. The tracking program 100 shows nothing on the screen and generates no sound on the connected computer X 103. The tracking program 100 is designed to run silently and invisibly without interfering with any operation of the flash drive 101 or the connected computer X 103. The virtual CD-ROM partition 200 is write-protected after pre-loading, so that the tracking program 100 is permanently protected from erasing. Ideally, this installation process should be done by a USB flash drive manufacturer.

The tracking program 100 is configured to include two of the owner's Internet email addresses 109 110 and URLs (Uniform Resource Locators) of relay programs 104 106 as well as an optional device identification, which is a unique string for identification of the electronic device. The configuration information 211 (such as email addresses, URLs and a device identification) is stored in a hidden (memory) area 201 of the USB flash drive 101. The hidden area 201 is a small portion of flash memory reserved by the manufacturer for storing configuration information 211 and is protected by a password (or security code), so that other programs and users can not access the information stored in the hidden area 201 except for the tracking program 100. The email addresses 109, 110 are preferably anonymous email addresses that have no indication of the owner's real name and identity for example, me2005@hotmail.com, NoRealName@yahoo.com. For the best result, each email address must have a different domain name from each other. For example, 500@hotmail.com, 500@gmail.com. A configuration (or setup) program may be used to make the configuration process user-friendly. This configuration program may be part of the tracking program or may be a separated and dedicated configuration program.

A device identification is provided by the owner and is optional information. For example, when someone has three USB flash drives in his/her possession, he/she may assign a nicknames “yellow”, “blue” and “red” as a nickname to each USB flash drive to distinguish one of his/her USB flash drive from another. The nickname can be used as device identification. Ideally, any specific characteristics of the electronic device such as serial number, make, and model that could be used to identify the device by anyone should not be used as a device identification. (An arbitrary or random number may be used as device identification, e.g. 2001, 2002. In this case, the owner should keep record of the random numbers and specifics of the actual electronic device that is associated with the random numbers.) In this way, others can not identify the real electronic device from the device identification even though the location information email 108 was eavesdropped. However only the owner can identify his/her own electronic device with the device identification.

A relay program 104 is installed in a remote computer A 105 that is connected to the Internet. The relay program is also installed in another remote computer B 107 that is connected to the Internet. This is repeated as many times as desired. The primary reason for installing identical copies of the relay program 104 in several different computers is to provide alternative email delivery paths, for example, 121 122 or 123 124, which are essential for fault-tolerance. Ideally, the relay program should be distributed in numerous remote computers that are connected to different ISPs (Internet Service Providers). So that when the service of an ISP becomes unavailable, it affects only one instance of the relay program while other instances of the relay program are unaffected. Diverse geographic distribution of the relay program also help increase availability. Each relay program should have a unique IP address. The relay program must not be inside an excessively restrictive (local area) network or computer that hinders incoming connections to the relay program or outgoing emails to an owner's email address. After installing the relay program 104 on different computers, a URL is assigned to each relay program, for example, TraceResultRelay.mycompany.com, One.TraceResultRelay.com, Two.TraceResultRelay.com. (The IP address of the computer can be either static or dynamic. In case of dynamic IP, Dynamic DNS can be used to bind a dynamic IP address to a URL. Thus, the remote computers 105, 107 in which copies of the relay program 104 106 are installed are not necessarily server computers. Ordinary desktop computers, laptops or pocket PCs could also be used to run a relay program 104.) Ideally, each of the URLs should use a unique domain name. The URLs are used by the tracking program 100 to connect a relay program 104 via the Internet. A major benefit of using a URL instead of an IP address for a relay program 104 is portability. A relay program 104 can be easily relocated to another location (another computer, IP address or domain name) when it is necessary.

A tracking program 100 transmits a location information email to a relay program when the tracking program cannot send the email 108 directly to the owner's email address 109, referring to 504. When the relay program 104 receives a location information email 108 from a tracking program 100 through any one of available ports, the relay program 104 immediately forwards the received email 108 to its intended recipient email address 109 by using the Internet email standard SMTP (Simple Mail Transfer Protocol). The relay program 104 is a dedicated email relay agent for tracking programs. The relay program 104 is intended to be used only by tracking programs. Thus the relay program 104 does not relay emails from other programs except the tracking programs. Consequently, third party or other programs, which are not a tracking program, can not use the relay program 104 to relay or forward an email. Furthermore, the relay program does not record any log and never cache any of the emails for privacy protection.

Referring to 301 in FIG. 3, each time the USB flash drive 101 is plugged into a USB port of a connected computer X 103, the tracking program 100 is automatically started and run in the connected computer X 103. First, the tracking program 100 determines the USB flash drive location by analyzing the network configuration of the connected computer X 103 as well as reading a set of GPS (Global Positioning System) coordinates if GPS is available, referring to 303 in FIG. 3. The location information includes IP addresses of the computer 103, where the IP addresses may include private IP address if it is available. The location information may also include GPS coordinates if GPS is available in the USB flash drive 101 or the computer 103, which the USB flash drive is plugged into. The GPS coordinates include longitude, latitude and altitude, where altitude is optional. The location information may further include host names of the computer 103.

The IP addresses, hostnames and GPS coordinates are the location of the connected computer X 103 to which the USB flash drive 101 is plugged (or connected). At the same time, the location information also indicates the USB flash drive location 101 because both the computer 103 and the USB flash drive 101 are in the same location. Thus, the IP addresses, hostnames and GPS coordinates are valid location for the USB flash drive. GPS coordinates are optional information.

Both public and private IP addresses of the computer 103 to which a USB flash drive 101 plugged in or connected can be obtained in various ways. Numerous IP address reading methods are all implemented and deployed for fault-tolerance. So that when one method fails to read an IP address, another method can be used. The first method of reading IP address is that the tracking program 100 automatically calls a win32 API (Application Programming Interface) GetNetworkParams. The second method is to call a Windows system program ipconfig.exe and reads a result from the call. Third method employs a ping command with “/r” argument. The fourth method uses a commercial or free IP address reading software component such as OstroSoft's oswinsck.dll, which can easily and safely be replaced with any other proprietary or commercial IP address reading software components. (Although some of these IP address reading methods are specific to Windows operating system, equivalent methods also exist in other operating systems.)

If any of above methods are unsuccessful, the tracking program 100 attempts to read the IP address with another method. If all the methods fail, the tracking program pauses for 5 seconds. The whole sequence is repeated until successful or up to 3 times. If all the IP address reading attempts fail, the tracking program 100 quits. Hostnames can be obtained in a similar way, or it can be obtained from DNS records.

When a GPS receiver is equipped in the computer 103 or USB flash drive 101, the tracking program 100 reads a set of GPS coordinates. If reading the GPS coordinates fails, the tracking program 100 pauses for 5 seconds and the sequence is repeated until successful or up to 3 more times. If a reading still fails after 3 times tries, the tracking program skips to the next step without further attempts.

After determining the location of the USB flash drive 101, the tracking program 100 detects location change by comparing the current location with the previous location, referring to 305. If the location has not changed, the tracking program 100 quits. Otherwise the tracking program 100 will go to the next step. If the previous location is undeterminable, the tracking program 100 will proceed to also go to the next step without this comparison.

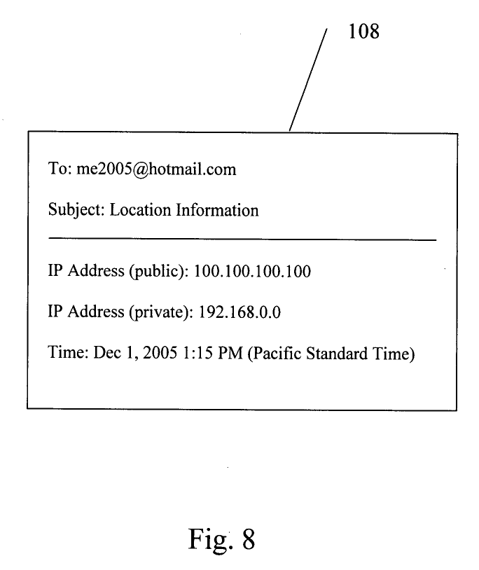

In the next step, the tracking program 100 composes a location information email 108, which includes location information and (current) time, as illustrated with flowchart step 307 in FIG. 8. The time is included in the email header as sent date/time. In addition, the time may also be added to the email body. Time may be obtained in several different ways. The easiest ways is to read time from the built-in system clock in the computer. If GPS coordinates are used, an alternative location information email 901 may be composed.

The tracking program 100 sends the location information email 108 to an owner's email address directly, referring to 309. The tracking program 100 quits after successfully sending a location information email 108 directly to the owner's email address from connected computer X 103.

If direct email delivery attempts are unsuccessful, the tracking program 100 sends a location information email 108 via a relay program on first remote computer A 105, referring to 311. If this attempt still fails, the tracking program 100 connects another instance of the relay program 106 on second remote computer B 107 to forward the location information email 108 to the owner's email address. Upon failure, the tracking program 100 continues to connect to other instances of the relay program until successful or until all instances of the relay program are tried. If all the described delivery procedures fail, the tracking program 100 starts the entire delivery procedure 399 over with an another email address of the owner 110.

The tracking program 100 has a time-out setting. The default value is 72 hours. If it can not send the location information email 108 within 72 hours, the tracking program 100 will quit. When the tracking program 100 successfully sends a location information email 108 (whether directly or via a relay program), the tracking program 100 saves the location information and quits, referring to 313. The tracking program 100 still quits even though the location information can not be saved due to an error or any other reason. When the USB flash drive 101 is unplugged and re-plugged, the entire procedure is started from the very beginning.

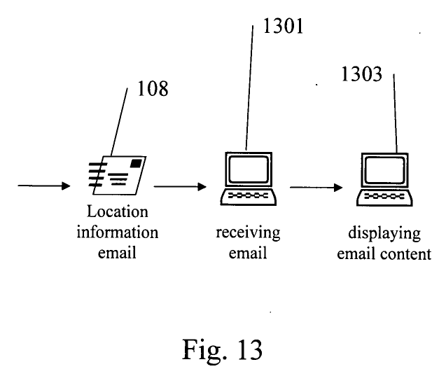

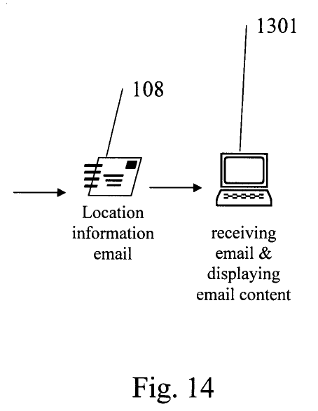

When a (location information) email is arrived at an owner's email address, the email is stored in a mailbox by an email receiving computer 1301. An email receiving computer 1301 receives emails that are sent to an email address and stores the received emails in a mailbox. The email may be downloaded from the mailbox to a user computer 1303 to display the email content on the user computer screen, referring to FIG. 13. An email receiving computer can be both an email receiving computer and a user computer at the same time. Thus, the email receiving computer 1301 can also be used to display the email content, referring to FIG. 14.

### Fault-Tolerance in Location Information Email Delivery

The present invention not only overcomes obstacles in location determination but also in location information email delivery. Location information email deliveries typically fail due to sender IP address blocking and TCP port blocking. The email receiving computer 1301 may block an email sent from a sender whose IP address is in a prohibited sender list. Firewall may block data traffic or connection to TCP port 25, so that an email delivery to the owner's email address through the port 25 fails. (Some Internet service providers such as America Online blocks port 25.) The present invention overcomes these obstacles by sending location information emails 108 from an alternative sender IP address when a sender IP address is blocked. The invention sends location information emails 108 from an alternative sender IP address when a sender IP address is blocked. Also the invention uses alternative TCP ports when the port 25 is blocked.

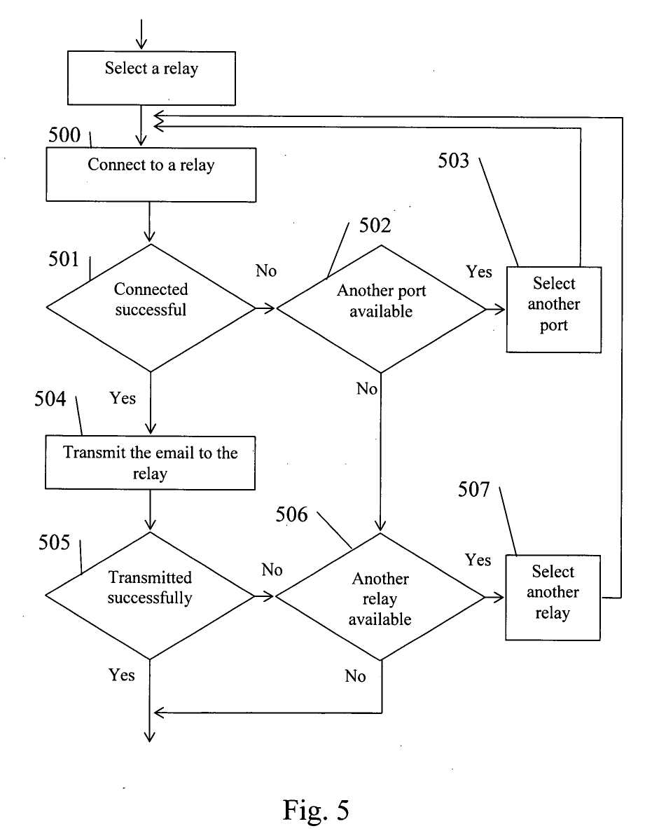

To solve the sender IP address blocking problem, the tracking program 100 sends a location information email 108 via a relay program 104 to the email receiving computer 1301. Since the tracking program 100 does not know precisely which IP addresses are blocked by the email receiving computer 1301, it uses a trial and error method. For example, when the tracking program 100 cannot send a location information email 108 via a relay program 104 (for any reason such as blocked sender IP address by an email receiving computer), then the tracking program 100 uses the relay program on another remote computer 107. At each attempt, the tracking program 100 uses the relay program on different remote computers to change sender IP address. The tracking program's attempt to send a location information email 108 via a relay program is repeated until a successful email delivery is accomplished or until all instances of the relay program in all remote computers are utilized. Referring to 500 in FIG. 5, when a rely program connects and tries to forward a location information email 108 to an email receiving computer 1301, the email receiving computer 1301 checks the IP address of the remote computer on which the relay program is running. If the email receiving computer 1301 recognizes the IP address as a prohibited IP address, then the email receiving computer 1301 will reject the email 108. As a result, the tracking program 100 won't be able to send the email 108 via the relay program on that specific remote computer. In this case, the tracking program 100 connects another instance of relay program on another remote computer, referring to a sequence of 506 507 500.

Since each relay program is on a different remote computer with a unique IP address, sending an email 108 via a different remote computer and relay program means a different sender IP address is seen by email receiving computer 1301. In other words, the email receiving computer 1301 sees a different sender IP address when the email 108 is sent from a relay program 104 on a different remote computer. As a result, the email receiving computer 1301 finally accepts an email 108 when the sender IP address is not in the prohibited list while tracking program 100 continues to send a location information email 108 with a different sender IP address at each attempt. Therefore the tracking program 100 can still send a location information email 108 even though the email receiving computer 1301 blocks the IP addresses for the computer X 103 hosting the tracking program 100 and one of the remote computers hosting a relay program 104. When relay programs 104 are distributed in multiple domain names, the described procedure of this invention also overcomes sender domain name blocking, e.g. when sender domain names are blocked instead of sender IP addresses. In addition, a firewall in a network may block the tracking program 100 from connecting a relay program 104 on a remote computer A 105. However the described method also overcomes such obstacles by connecting to another instance of the relay program on another remote computer.

The tracking program 100 uses another fault-tolerant method to deal with the port blocking problem. When a TCP port is blocked or whatever reason the tracking program 100 cannot connect to a relay program running on a remote computer, the tracking program 100 uses another port to connect. For example, the tracking program 100 first tries to connect to a relay program 104 on a remote computer 105 through the TCP port 25, referring to 500. If this attempt fails, it tries well-known ports followed by other available ports, referring to a sequence of 501 502 503 500. When these attempts still can not establish a connection to a relay program 104, the tracking program 100 connects another instance of relay program on another remote computer, referring to the sequence of 501 502 506 507 500. (FIG. 5) Thus a location information email 108 can be sent through any one of available ports even though the port 25 or some other ports are blocked between tracking program 100 and the relay program 104. Thus the described procedure solves the port blocking problem.

Note: port 25 blocking from a relay program 104 to an email receiving computer 1301 is not an issue. The relay program. 104 is running inside of a network or a computer that does not hinder outgoing emails. At the same time, the port 25 is also always open for email receiving computers 1301.

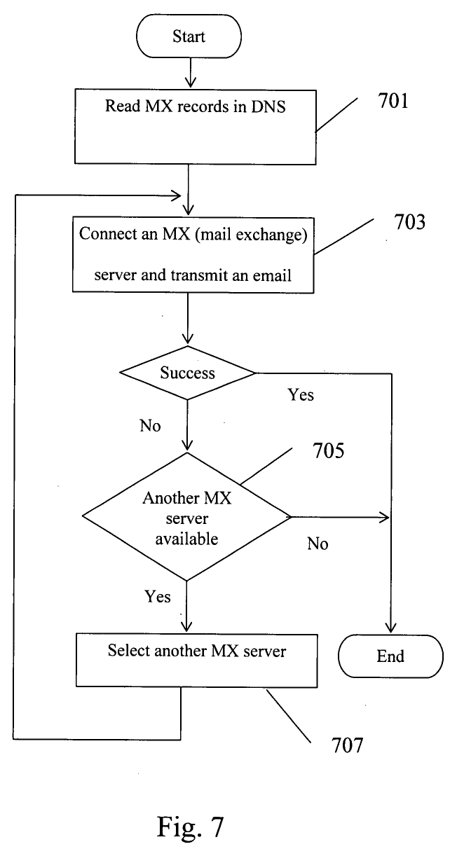

Email receiving computers 1301 are usually a mail exchange server for the owner's email domain. The mail exchange server is specified in the DNS (Domain Name System) MX (Mail exchange) records and is responsible for receiving incoming emails for its domain. Referring to FIG. 7, to determine a correct mail exchange server for the owner's email address, the tracking program 100 and relay program 104 read the MX records in the DNS for the owner's email domain name 701. For example, when the owner's email address is ‘me2006@yahoo.com’, the owner's email domain is yahoo.com. The current MX record for yahoo.com DNS indicates that there are four mail exchange servers (at the time of this writing): mx1@yahoo.com, mx2@yahoo.com, mx3@yahoo.com, and mx4@yahoo.com. The tracking program 100 and relay program 104 connect these computers 703, which are email receiving computers for the owner's email address and always receive emails through the port 25.

Other reasons for location information email delivery failure include mail exchange server failure, contents filtering and virus blocking. This invention also overcomes mail exchange server failure problem by using an another email address of an owner, referring to 705 707, 703. Contents filtering and virus blocking do not cause the location information email 108 delivery problem. A location information email 108 does not contain any objectionable contents, for example, commercial solicitation or a virus. Thus these are not considered problems for location information email deliveries. The owner can easily solve or prevent such issues (if there is any) by contacting ISP or a network administrator of the email address in advance.

The successful email delivery can be determined by responses from the email receiving computer 1301 for the owner's email address (the mail exchange server). The response is SMTP Status Codes, which indicate whether it is successful or not. For example status code 220 means initial connection success. Status code 250 means OK. Status code 500 means syntax error. And so on. Email transmissions or deliveries use SMTP, which is the de facto standard for the Internet emails. SMTP and SMTP Status Codes are defined by publications of IETF (Internet Engineering Task Force), the standard organization for the Internet.

There are some measures that help increase chances of email delivery success. For example, reverse DNS may be setup for each IP address that is assigned to a relay program. This helps increase chances of email delivery. Reverse DNS setup is accomplished by specifying hostname for the IP address in a PTR record in domain name system (DNS). This allows reverse DNS lookup by the email receiving computer. Because some email receiving computers 1301 do not accept emails from IP address whose hostname is not matched in reverse DNS lookup. Furthermore, tracking programs 100 and relay programs 104 may have a capability to automatically discover proxy servers in a LAN (local area network) and connecting the destination. Many applications are already capable of automatically discovering proxy servers in LAN. For example Microsoft Internet Explorer is using WPAD (Web Proxy Autodiscovery Protocol). The same or similar method can be easily applied to tracking program and relay program for proxy server discovery purpose. Moreover, yet another email delivery path may be used. Each ISP (Internet Service Provider) provides SMTP server for its subscribers. The SMTP server could be used in sending email when all the described email delivery attempts fail.

### Locating a USB Flash Drive

When the USB flash drive 101 is plugged into a computer X 103 having Internet access, the tracking program 100 is automatically started and run in the computer. The tracking program 100 determines location of USB flash drive 101 and sends the location information to an owner's email address 109 as described. The location information is very valuable, especially when the USB flash drive 101 is stolen 101. The location information may or may not contain a set of GPS coordinates depending on availability of GPS. Although, even if a set of GPS coordinates is unavailable, (public) IP address, private IP address, hostnames, and time are sufficient to locate a stolen device or sufficient to find a person who uses a stolen USB flash device. When the owner reports theft to the police, the police obtains the street address corresponding to the IP address by contacting the ISP (Internet Service Provider), whom the IP address is managed by or the IP address belongs to. In case the stolen device was connected via a wireless Internet, it is preferred to obtain the name and address of the Internet service subscriber, who connected to the wireless Internet with the stolen device. The subscriber may be the suspect or may lead to the suspect. The IP addresses and hostnames provide useful information to recover the stolen device.

Each location information email 108 contains location information of the USB flash drive at a moment of the time. Each location information can be marked as a dot on a map. All other location information can also be marked on the map. A collection of the dots represents a trail of the device movement. Marking dots on the map can be done by software, which automatically reads location information from the location information emails 108 and draw dots on the map in the computer screen.

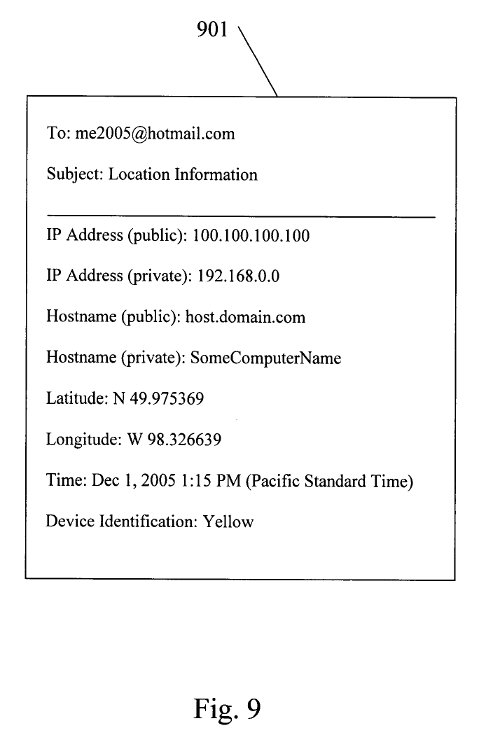

The location information is only delivered to the owner's email address 109. In the event the email 108 is ever intercepted, the email contains no personally identifying and no electronic device identifying information, referring to FIG. 8. (The email may contain optional device identification, referring to FIG. 9. But it is only meaningful for the owner. Others can not identify the device from the device identification.) Thus owner's privacy is still safe even though a location information email is intercepted (and viewed by others).

Encryption of the location information email 108 is unnecessary in most cases because it is reasonably safe and secure without encryption. However, the contents of the location information email 108 can be encrypted if the owner prefers. Encryption can provide additional privacy protection in a case that a spelling of an email address that the owner provides reveals his/her real name. For example, when an unencrypted location information sent to true_name@somecompany.com is intercepted, the privacy of the owner may be at risk due to the email address itself hints the owner's real name and the email contains location information. But encryption will hide the contents including the location information and ensure privacy even though explicit email address revealing the owner's name. Thus encryption provides additional privacy safety.

Although the programs in this embodiment are designed for Microsoft Windows operating systems, the programs can also be designed for other operating systems. Using three or more owner's email addresses instead of two could achieve a higher level of fault-tolerance. A great number of relay programs in diversified geographic locations also help achieve a higher degree of fault-tolerance. A relay program can also be implemented as firmware or a microprocessor. Yet a relay program 104 can be implemented as a standalone hardware device that is connectable to the Internet, a network having Internet access, or a computer having Internet access. The required Internet connection for the embodiment is either wired or wireless Internet connection. The invention works regardless of differences in connection means even though a wireless Internet connection may be desirable for a tracking-program 100 in some other embodiments.

Tracking programs 100 may have additional functions such data destruction by a remote control means. A remote control program may be installed in an owner's desktop, laptop, cell phone, or server computer. The owner can remotely destroy data stored in the flash drive 101. When the owner sends a data destruction command with his/her remote control program to the tracking program 100 via the Internet, the tracking program 100 securely destroys the data stored in the flash drive 101. Besides the data destruction command, the remote control could be designed to send other commands if it is desired.

In one of the simplest embodiments, location change detection 305 and direct email delivery attempt 309 could be omitted.

This embodiment was described with USB but all the features are equally applicable to Wireless USB. Likewise, IP address examples are given in IPV4 (Internet Protocol version 4) but it is equally applicable to IPV6 (Internet Protocol version 6).

### An Embodiment for Tracking Laptop

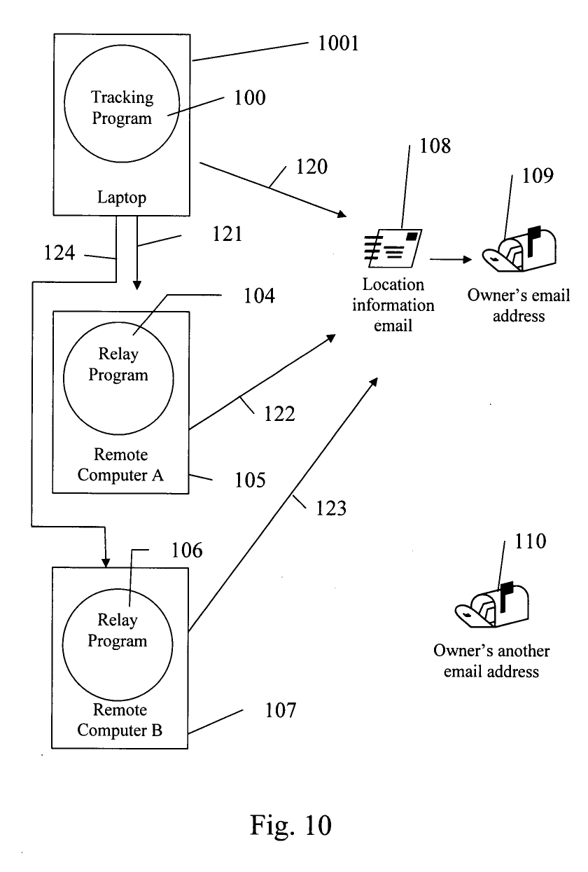

Another embodiment of the invention tracks location of a laptop. (FIG. 10) A tracking program 100 is installed in a laptop 1001 that uses a Microsoft Windows operating system, and the tracking program 100 is configured to automatically start and run when the operating system starts. (The tracking program 100 is designed as a service program for Microsoft Windows operating system. So that the tracking program is automatically started when the operating system starts.) The tracking program 100 and the relay programs 104 use the same method described in the previous section (An Embodiment For Tracking USB Flash Drive) to determine location and send location information to an owner's email address.

To protect the tracking program 100 from unauthorized tampering and formatting the hard drive in which the tracking program 100 is stored, BIOS (basic input and output systems) configuration should be adjusted as follows: 1) Boot only from the primary hard drive (default is usually C drive). 2) Enable a supervisor password for BIOS setting changes. After this setting, the computer will only boot from the primary hard drive. A supervisor password is required to change the BIOS settings. This prevents unauthorized users from tampering with the computer system or formatting the hard disk drive.

Although this embodiment is designed specifically for a Microsoft Windows operating system, this invention can be embodied for any other operating systems such as Linux. Alternatively, the tracking program can be stored in the computer's firmware and automatically executed each time computer starts. Yet alternatively, the tracking program may be integrated into the operating system.

### An Embodiment for Tracking Vehicle

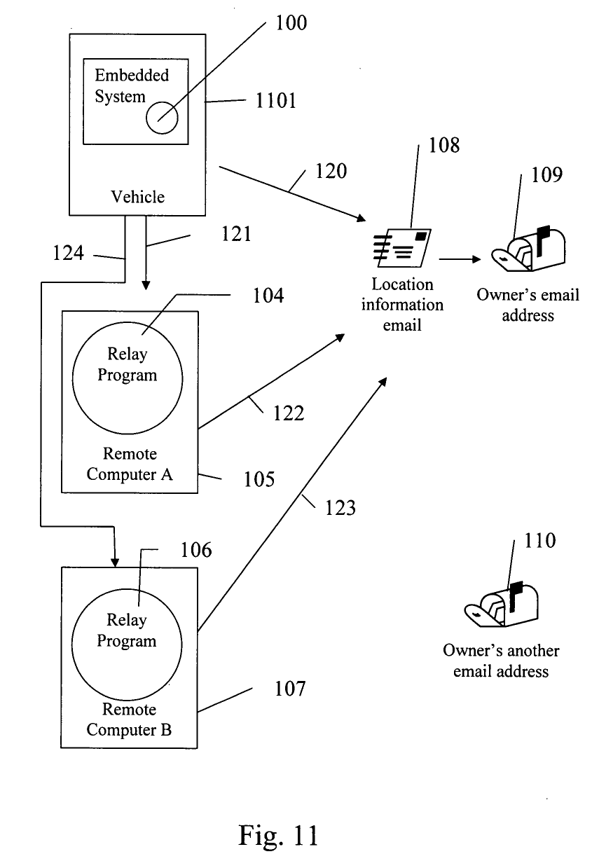

Another embodiment of this invention tracks location of a vehicle 1101. (FIG. 11) The tracking program 100 can be installed in an embedded system (embedded computer, single board computer, or on-board computer) that is equipped with a GPS receiver and is capable of connecting to a wireless Internet. An embedded system is a special-purpose system or a computer that is designed to perform a specific task. When the tracking program is installed in the embedded system, the embedded system becomes location tracking device and is capable of sending location information of an object or equipment that the device is attached to. The tracking device can be securely attached to the inside of the vehicle or may be embedded inside of car stereo.

The tracking program 100 and the relay programs 104 use the same method described in the previous section (An Embodiment For Tracking USB Flash Drive) to determine location and send location information emails 108 to an owner's email address. However an exception is that the tracking program 100 installed in the tracking device is configured to automatically and periodically start every 30 seconds. So that the location information is sent every 30 seconds only when the location of the tracking device is changed due to vehicle movement. Thus location information won't be sent out when the location of vehicle is not changed. The interval may be adjusted for an optimal result.

Unlike the previous embodiment for tracking USB flash drive 101 or laptop 1001, this embodiment requires a wireless Internet connection such as WiMax, Internet connection via GPRS (General Packet Radio Service) or Internet connection via satellite service. Alternatively the tracking program 100 can be implemented as a firmware or a microprocessor in the tracking device.

### An Embodiment for Tracking Other Objects

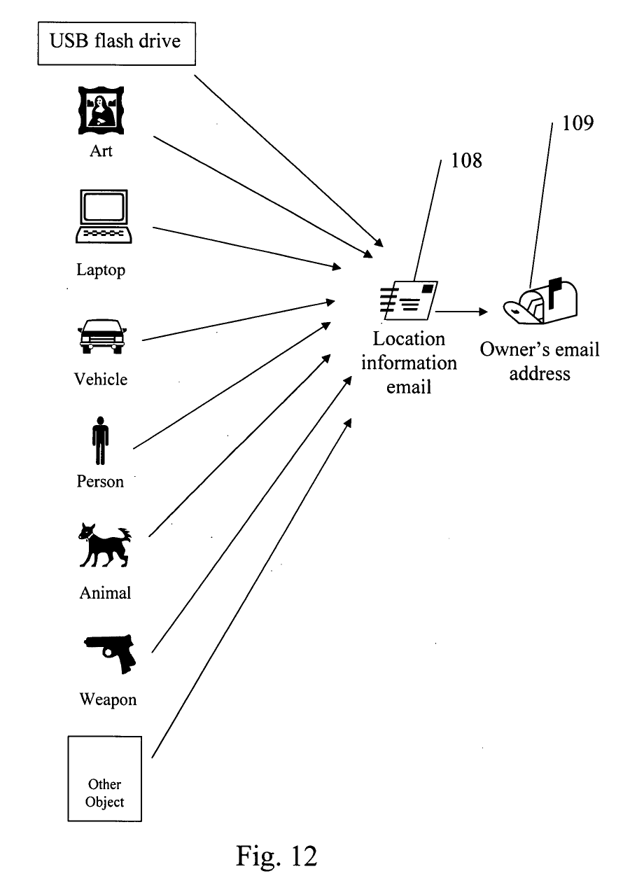

Referring to FIG. 12, it can be seen that a miniaturization of the tracking device (an embodiment for tracking vehicle) allows broader applications of the invention. A miniaturized tracking device can be attached to various objects such as cargoes, parcels, luggage, bicycles, key chains, dog collars, wristbands, and so on. This embodiment can also track the location of an animal or a person. For example, the tracking device can be attached to a dog collar, which is worn by a dog or other animal to be tracked. Furthermore, the tracking device can be attached to a wristband or a belt that is worn by a person to be tracked.

When the tracking device is further miniaturized, it can be embedded or implanted in various big and small objects such as toys, golf balls, skis, jackets, hats, picture frames, musical instrument, antiques, guns, other weapons, shoes, credit cards, coins, bank notes, checks, wallets, jewelry, wine bottles, books, wristwatches, medical instruments, medicine bottles, and so on. As shown, this invention can also track location of any non-electronic object that the tracking device is attached to, embedded in or implanted in.

### An Embodiment for Tracking CD-ROM

The Embodiment For Tracking USB Flash Drive is also applicable to tracking location of a CD-ROM (Compact Disc Read Only Memory). The tracking program is stored (or preloaded) in a CD-ROM instead of the virtual CD-ROM of USB flash drive. The configuration information is stored in the CD-ROM (as a file) instead of a hidden area 200 of a USB flash drive 101.

This embodiment uses the same autorun.inf. When the CD-ROM is inserted into a CD-ROM drive of a computer, the tracking program is automatically started and run in the computer. The tracking program performs the identical operation described in the Embodiment For Tracking USB Flash Drive. This embodiment is also applicable to DVD-ROMs (Digital Video Disc Read Only Memory), external USB hard disk drives and all other computer storage media that can be configured to automatically run a program in a computer.

### An Embodiment for Tracking None Physical Object

This invention can also be applied to track location of non-physical objects such as an application program. A tracking program 100 is appended or embedded in an application program to automatically start and run when the application program is started in a computer (or an electronic device). For example, a tracking program 100 could be appended or embedded in Microsoft Word program WinWord.exe to automatically run upon starting of WinWord.exe program. Each time WinWord.exe program is started, the tracking program 100 is also started. The tracking program 100 determines its location and send a location information email 108 as described in the previous section. The location of the WinWord.exe program is the same as the location of the computer in which WinWord.exe is being executed. Thus the computer location is an acceptable location information for the WinWord.exe program.

A tracking program 100 can also be embedded in DRM (Digital Right Management) system (or an operating system) to send location information of a music or video file to the copyright owner upon opening or playing the music or video file. A tracking program 100 can also be embedded in a word processor program to send location information of a document file to the copyright owner upon opening the file. Furthermore, this invention is applicable to track location of other files, which are being executed, opened, or being played in a computer or an electronic device.

### Alternative Embodiments

So far Mail Exchange (MX) servers were used as an example of an email receiving computer. However, there are several alternatives for email receiving computers. (Email receiving computers can be a laptop or even pocket PC without using or depending on Mail Exchange servers.) For example, ePOST (of epostmail.org), a serverless peer-to-peer email system, provides the same type of the Internet email service as normal email systems without using email server such as Mail Exchange servers. This invention also works with ePOST systems. The owner can run ePOST system in a laptop computer and receive location information emails from the tracking program as well as regular Internet emails. Using serverless email system such as ePOST could better protect the owner's privacy.

Although Internet and SMTP protocol is used in the presented embodiments, alternative communication network and protocols could be used such as X.400, AMTP (Authenticated Mail Transfer Protocol), or even a proprietary protocol could be used instead of SMTP.

This invention just sends location information to an Internet email address. Thus there is no need for re-inventing an email receiving system or computer. (FIG. 6) However a proprietary email receiving system could still be designed if there is any benefit in doing so. The presented embodiments could easily be modified to work with a proprietary email receiving system.

Furthermore, Instant messaging (IM) or Short Message Service (SMS) could also be used in delivering location information to the owner. Still more, an encrypted location information could be delivered to (or posted on) an Usenet (USEr NETwork) newsgroup such as alt.test or an Internet bulletin board, from which the owner can retrieve and decrypt the location information. Such none email based location information delivery system could be used as an additional location information delivery means for the presented embodiments or could be used in an emailess embodiment, which use no email.

The above description will enable any person skilled in the art to make and use this invention. It also sets forth the best modes for carrying out this invention. There are numerous variations and modifications thereof that will also remain readily apparent to others skilled in the art, now that the general principles of the present invention have been disclosed. As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Having thus described the invention, what is claimed as new and desired to be secured by Letters Patent is as follows:

1. A method for locating an electronic device, comprising the steps of:
1. embedding or installing a relay agent in at least one remote computing unit capable of connecting to the internet;
2. embedding, installing or loading a tracking agent in said electronic device to automatically start and perform the sub-steps of:
a) determining location of said electronic device,
b) composing a location information email including said location information and current time,
c) sending said location information email directly to an email address, and
d) in the event of failure of said location information email to reach said email address, transmitting said location information email to said relay agent on said remote computing unit;
3. receiving said location information email by said relay agent from said tracking agent; and
4. forwarding said location information email to its intended recipient email address by said relay agent.

2. The method for locating an electronic device of claim 1 further comprising the steps of:
transmitting said email to another said relay agent on another said remote computing unit upon failure of said email to reach said email address;
receiving said email by said another relay agent from said tracking agent; and
forwarding said email to its intended recipient email address by said another relay agent.

3. The method for locating an electronic device of claim 2, wherein said steps of claim 2 are repeated as many said remote computing units that were installed or embedded with said relay agent or until said email successfully arrives at said email address.

4. The method for locating an electronic device of claim 1, said electronic device is connectable to the Internet, connectable to a computer having Internet access or connectable to any network having Internet access.

5. The method for locating an electronic device of claim 1, wherein said email includes information selected from the group consisting of IP addresses, private IP addresses, hostnames, device identification, GPS (Global Positioning System) coordinates, and other information that may be informative for the owner.

6. The method for locating an electronic device of claim 1 further comprising the steps of:
5. repeating steps 2(c) to 4 with another email address in the event that said email was undeliverable to said email address.

7. The method for locating an electronic device of claim 6 further comprising the steps of:
transmitting said email to another said relay agent on another said remote computing unit upon failure of said email to reach said another email address;
receiving said email by said another relay agent from said tracking agent; and
forwarding said email to its intended recipient email address by said another relay agent.

8. The method for locating an electronic device of claim 7, wherein said steps of claim 7 are repeated as many said remote computing units that were installed or embedded with said relay agent or until said email successfully arrives at said another email address.

9. The method for locating an electronic device of claim 1, wherein said tracking agent is configured to include email addresses, a device identification for said electronic device said tracking agent is imbedded in or on, and at least one URL corresponding to a relay agent's location.

10. The method for locating an electronic device of claim 1 further comprising the fifth step of:
5. repeating steps 2(a) to 4 automatically on an established time interval.

11. The method for locating an electronic device of claim 1, wherein said email is encrypted.

12. The method for locating an electronic device of claim 4, wherein said device is an electronic device selected from the set consisting of USB flash drives, computers, digital cameras, digital music players, cell phones, televisions, video game consoles, internet radios, vehicle on-board computers, other electronic devices connectable to a USB port and all electronic devices capable of imbedding said tracking agent.

13. The method claim 9 further comprising an initial step of:
using a configuration setup program that guides the user in step by step instructions for configuring the tracking agent.

14. The method for locating an electronic device of claim 1, wherein said tracking agent is selected and loaded from the set of devices capable of holding machine executable instructions thereon, consisting of CD-ROMs (Compact Disc Read Only Memory), DVD-ROMs (Digital Video Disc Read Only Memory), external USB hard disk drives or any other computer storage media that can be configured to automatically start and run a program in a computer.

15. The method of claim 1, wherein said tracking agent always performs its tasks surreptitiously without any visible or audible signals generated.

16. The method for locating an electronic device of claim 4, wherein said electronic device is equipped with a GPS receiver and is attached to, embedded in or implanted in a non-electronic object to track its location.

17. The method for locating an electronic device of claim 1, wherein said electronic device can be substituted with an application program or an operating system.

18. The method for locating an electronic device of claim 1, wherein said tracking agent erases data in hard disk drive or memory of said electronic device upon receiving data erase signal from a remote control.

19. The method for locating an electronic device of claim 1, wherein said email address is an email address that is designated by said electronic device owner, a legal representative, an assignee or a guardian.

20. The method for location an electronic device of claim 8 further comprising the step of:
sending contents of said email to an instant messaging (IM) account in the event that said email was undeliverable to said another email address.

21. The method of claim 1, wherein said location information email is not sent if location of said electronic device is not changed.

22. The method for locating an electronic device of claim 1, wherein said tracking agent and said relay agent are selected from the set of agents comprising software, firmware, microprocessors or other hardware.
